(19) United States
(12) Patent Application Publication
(10) Pub. No.: US 2007/0091900 A1
(43) Pub. Date: Apr. 26, 2007

(54) Prioritized control packet delivery for transmission control protocol (TCP)

(75) Inventors: Sarvesh Asthana, San Diego, CA (US); Sreenivas Addagatla, San Diego, CA (US); Jagdish Gopalakrishnan, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/254,345

(22) Filed: Oct. 20, 2005

(51) Int. Cl. H04L 12/56

(52) U.S. Cl. 370/395.42; 370/464

(57) ABSTRACT

A method is provided for transmitting data, wherein control packets are given priority with respect to application data packets. In general, this is accomplished by establishing a separate, distinct link flow over which only control packets (e.g., TCP control packets) will be transmitted. A higher priority is associated with this link flow. In addition, the reliability of control packets sent over the dedicated link flow can be improved upon by increasing the number of retransmissions associated with the control packets and/or decreasing the window of time before the retransmissions are sent. A system, mobile terminal, network entity, and computer program product for implementing the method are also provided.

### FIELD OF THE INVENTION

Exemplary embodiments of the present invention relate to the Transmission Control Protocol (TCP), and more particularly to the transmission of TCP control packets.

### BACKGROUND OF THE INVENTION

TCP is the most common transport protocol used by Internet applications. TCP provides a connection-oriented, reliable transport mechanism for applications and includes acknowledgement-based retransmissions, flow control and congestion control. TCP is layered over Internet Protocol (IP) as the underlying network protocol. Examples of TCP applications include web browsing, e-mail, and file-transfers, to name a few.

A typical TCP packet can include control information (e.g., related to connection establishment) and/or application data. The control bits field in the protocol header indicates the presence of control information (i.e., when a control bit is set). Examples of control bits include URG, indicating that the data is urgent; ACK, indicating an acknowledgement; PSH, meaning end-of-letter or push; RST for reset; SYN for synchronize; FIN for finish; CWR for congestion-window-reduced; and ECE, which is an explicit congestion notification (ECN) echo flag. TCP headers also include an options field to facilitate negotiation of buffer sizes and future extensions.

As used herein, a control packet refers to a TCP packet having one of the control bits or options set, without any application data (i.e., data length being zero). TCP packets without any application data are also referred to as empty segments, since they have a TCP header but no application data.

An application running over TCP is either a server application (i.e., it accepts connections), a client application (i.e., it initiates connections to a server), or both. A client application may, for example, be operating on a mobile terminal wishing to establish a TCP connection with another mobile terminal, on which a server application would, therefore, be operating. Before transmitting any data, a client initiates a connection to a server by sending an empty segment, indicating intent to connect (i.e., the SYN bit is set in the control field). If the server is willing to accept this request, it responds with an acknowledgement (i.e., with both the SYN and ACK bits set), again in an empty segment. Otherwise, the server will transmit a reset packet, with RST and ACK bits set. Where the former occurred, the client confirms the connection by sending another empty ACK packet (i.e., with only the ACK bit set). This SYN-[SYN-ACK]-ACK exchange is typically referred to as a three-way handshake mechanism for connection establishment.

For most applications, the application data after a connection is established flows in one direction (e.g., from a web server to a web browser or from a file server to a downloader), in which case, the receiving end transmits many empty acknowledgements to the sender (i.e., an empty segment with the ACK bit set).

Data exchange according to TCP, therefore, includes certain control packets related to connection establishment (e.g., SYN and ACK), disconnection (e.g., RST and FIN), and empty acknowledgements, which prevent unnecessary retransmissions and slow-down of data rate. These control packets, while they do not carry application data, are very important in keeping the connection alive and data flows optimal.

While TCP control packets are presumably transmitted at a lesser volume and frequency than application data, the consequences of control packets being lost are greater than that of packets containing only application data. Currently, however, the critical nature of TCP control packets is not taken into consideration. TCP data traffic can, therefore, affect the TCP control packet delivery. In this regard, TCP control packets may be delayed pending delivery of TCP data traffic.

The problem is even more prominent in wireless access networks (e.g., CDMA2000 (Code Division Multiple Access) 1×EV-DO (Evolution-Data Only)) where all of the various socket packets share the same air link to the Base Station Controller (BSC)/Packet Data Serving Node (PDSN), thereby potentially further delaying delivery of TCP control packets.

A need, therefore, exists for a method of giving priority to the TCP control packet traffic such that any delays in the delivery of TCP control packets pending delivery of TCP data packets are reduced.

### BRIEF SUMMARY OF THE INVENTION

Generally described, exemplary embodiments of the present invention provide an improvement over the known prior art by, among other things, providing a method of prioritizing TCP control packet traffic over TCP application data traffic. In particular, exemplary embodiments propose establishing a separate, dedicated link flow exclusively for TCP control packets, wherein the link flow established has a higher priority (i.e., higher quality of service (QoS) requirements) than the link flow used for data traffic. Increasing the priority of the link flows used to transmit TCP control packets may, for example, result in faster packet queue processing times for TCP control packets with respect to application data packets.

In addition to increasing the priority, the separate control link flow may also effect an increase in the reliability of the TCP control packets by, for example, increasing the number of retransmissions in the link and physical layers of TCP control packets in comparison to retransmissions of regular data traffic. In other words, where, for example, either an acknowledgement is not received for a TCP control packet after a predefined window of time has expired or, alternatively, a NACK, or negative acknowledgement, is received indicating that the packet was not received, the sender may retransmit the control packet a greater number of times than it would in a similar instance with regard to an application data packet. Alternatively, or in addition, link layer retransmission of TCP control packets may occur after a shorter time window than application data traffic. For instance, the sender may wait 20 milliseconds before retransmitting a TCP control packet, while it may wait 40 milliseconds before retransmitting an application data packet (note that all units of time are indicative only, and should not be taken in a normative manner). By having a separate, dedicated control link flow, the mobile terminal is able to establish differing link layer retransmission rates (i.e., differing number of retransmissions and/or differing time windows) for TCP control packets as compared to regular application data.

According to one aspect of the invention, a method of transmitting one or more control packets and one or more application data packets is provided. In one exemplary embodiment, the method includes: (1) associating a first link flow with transmission of the one or more control packets; (2) associating a second link flow with transmission of the one or more application data packets; (3) transmitting one or more control packets over the first link flow; and (4) transmitting one or more application data packets over the second link flow, wherein the one or more control packets have a higher priority than the one or more application data packets, and wherein transmitting one or more control packets over the first link flow comprises transmitting the one or more control packets with the higher priority over the first link flow.

In one exemplary embodiment, the first link flow is more highly prioritized than the second link flow. In other exemplary embodiments, the method further includes including a marking with respective control packets to indicate the priority of the control packets.

In one exemplary embodiment, the control packets are TCP control packets and the application data packets are TCP application data packets. The method may further include defining a number of times a link layer frame containing a TCP control packet will be retransmitted, wherein the number of times the frame will be retransmitted is greater than the number of times a link layer frame containing a TCP application data packet will be retransmitted. In other exemplary embodiments the method may include defining the window of time before the link layer frame containing a TCP control packet will be retransmitted, wherein the window of time is shorter than the window of time before the link layer frame containing a TCP application data packet will be retransmitted.

In one exemplary embodiment the control packets are transmitted from a mobile terminal to an intermediate agent. In this exemplary embodiment, the markings included with respective control packets indicate to the intermediate agent the priority of the one or more control packets. In one exemplary embodiment, the method further includes establishing a packet filter at the intermediate agent, wherein the packet filter can be used by the intermediate agent to route one or more control packets intended for the mobile terminal over the control link flow in accordance with the priority of the control packets.

According to another aspect of the invention, a mobile terminal is provided that is capable of transmitting one or more control packets and one or more application data packets. In one exemplary embodiment, the mobile terminal includes a processor and a memory, wherein the memory includes an application that is executable by the processor. In one exemplary embodiment the application, upon execution, is capable of: (1) associating a first link flow with transmission of the one or more control packets; (2) associating a second link flow with transmission of the one or more application data packets; (3) transmitting one or more control packets over the first link flow; and (4) transmitting one or more application data packets over the second link flow, wherein the one or more control packets have a higher priority than the one or more application data packets, and wherein transmitting one or more control packets over the first link flow comprises transmitting the one or more control packets with the higher priority over the first link flow.

According to yet another aspect of the invention, a system for transmitting one or more control packets and one or more application data packets is provided. In one exemplary embodiment, the system includes a mobile terminal and a network entity in communication with the mobile terminal. The mobile terminal of exemplary embodiments is capable of associating a first and second link flows with transmission of the one or more control packets and the one or more application data packets, respectively. The mobile terminal of one exemplary embodiment is further capable of transmitting one or more control packets over the first link flow, and transmitting one or more application data packets over the second link flow, wherein the one or more control packets have a higher priority than the one or more application data packets, and wherein transmitting one or more control packets over the first link flow comprises transmitting the one or more control packets with the higher priority over the first link flow. The network entity of exemplary embodiments, in turn, is capable of receiving the control packets with the higher priority from the mobile terminal.

According to another aspect of the invention, a network entity is provided that is capable of sending and receiving one or more control packets with a higher priority than one or more application data packets. In one exemplary embodiment, the network entity comprises a processor and a memory in communication with the processor, wherein the memory stores an application that is executable by the processor. In one exemplary embodiment, the application is capable, upon execution, of: (1) receiving one or more control packets over a control link flow and one or more application data packets over an application data link flow; (2) interpreting a marking included with respective control packets received to determine a priority of the control respective control packets; and (3) transmitting the control packets received in accordance with the priority.

According to another aspect of the invention a computer program product is provided for transmitting one or more control packets and one or more application data packets. The computer program product comprises at least one computer-readable storage medium having computer-readable program code portions stored therein. In one exemplary embodiment these computer-readable program code portions may include: (1) a first executable portion for associating a first link flow with transmission of the one or more control packets; (2) a second executable portion for associating a second link flow with transmission of the one or more application data packets; (3) a third executable portion for transmitting one or more control packets over the first link flow; and (4) a fourth executable portion for transmitting one or more application data packets over the second link flow, wherein the one or more control packets have a higher priority than the one or more application data packets, and wherein transmitting one or more control packets over the first link flow comprises transmitting the one or more control packets with the higher priority over the first link flow.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a simplified block diagram illustrating the use of a control link flow for transmitting TCP control packets to and from a mobile terminal in accordance with exemplary embodiments of the present invention.

FIG. 2 is a block diagram of one type of system that would benefit from exemplary embodiments of the present invention;

FIG. 3 is a schematic block diagram of an entity capable of operating as a mobile terminal, an intermediate agent, a web server and/or a file server in accordance with exemplary embodiments of the present invention;

FIG. 4 is a schematic block diagram of a mobile terminal capable of operating in accordance with an exemplary embodiment of the present invention;

FIG. 5 is a flow chart illustrating the steps which may be taken in order to prioritize TCP control packets in the uplink from the mobile terminal to the network; and

FIG. 6 is a flow chart illustrating the steps which may be taken in order to prioritize TCP control packets in the downlink from a CDMA network to a CDMA mobile terminal.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention are described herein primarily in conjunction with wireless access networks following the CDMA2000 1×EV-DO standard. This is for exemplary purposes only and should not be construed as limiting the present invention to any one access network or standard. In contrast, as one of ordinary skill in the art will recognize, exemplary embodiments may be implemented in conjunction with any other packet-switched communication network capable of supporting communication in accordance with various 2.5G, 3G or 4G protocols such as, Global System for Mobile Communications (GSM) General Packet Radio Service (GPRS) or Enhanced Data Rates for GSM Evolution (EDGE), CDMA2000 1xRTT (Radio Transmission Technology), CDMA2000 1×EV-DV (Evolution-Data and Voice), or Universal Mobile Telephone System (UMTS) based on Wideband Code Division Multiple Access (WCDMA) technology.

For wireless access networks, such as those capable of supporting communication in accordance with CDMA2000 1×EVDO, the link layer provides the capability to set up different connections, referred to as link flows, with the base station. These link flows can in turn have different levels of QoS. For example, link flows having differing packet queuing processing times may be established. According to exemplary embodiments of the present invention, a separate, dedicated link flow may be established for TCP control packet traffic, wherein the link flow established is more highly prioritized than the existing link flow carrying application data traffic. This may result, for example, in TCP control packets transmitted over the dedicated control link flow having a faster packet queuing processing time than application data traffic over the separate link flow marked with a lower priority.

This priority may be provided in various manners. For example, the mobile terminal's underlying operating system may internally process the TCP control packets faster than or before it processes or transmits application data traffic. In other words, because the mobile terminal is only assigned a certain bandwidth to use for TCP traffic generally, the mobile terminal may give preference to TCP control packets over application data packets. In addition, or alternatively, priority may be given to TCP control packets when they are transmitted from one intermediate agent (e.g., a router or PDSN) associated with the sender to the recipient or an intermediate agent associated with the recipient. This may occur through the use of Differential Service Code Points (DSCPs) included in the IP header of the TCP control packets sent over the control link flow. While two techniques for prioritizing the TCP control packets are provided, the TCP control packets may be prioritized in other manners with respect to the application data traffic, as are known in the art, either in addition to or instead of the foregoing.

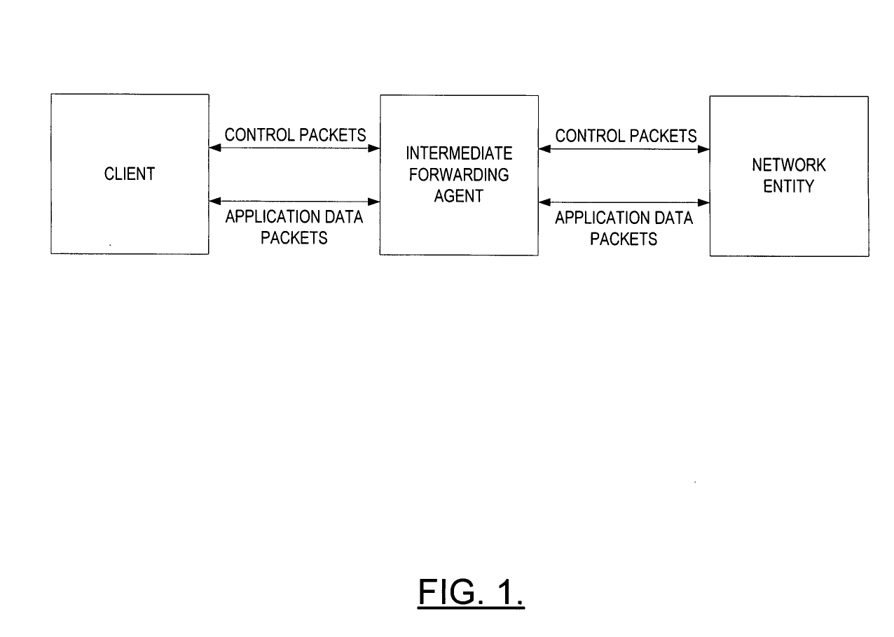

In one exemplary embodiment a separate control link flow having an elevated priority level is only used for TCP control packets transmitted on the uplink from the mobile terminal to the network. Alternatively, in other exemplary embodiments, TCP control packets transmitted on the downlink from the network to the mobile terminal are similarly (or alternatively) transmitted over a separate control link flow having the same elevated priority level. FIG. 1 is a simplified block diagram illustrating one exemplary embodiment wherein TCP control packets are transmitted in both directions over the control link flow having a higher priority.

In other exemplary embodiments, the control link flow may also be used to increase the reliability of TCP control packets. For example, the TCP control packets may be retransmitted a greater number of times over the control link flow than the regular data traffic over the original link flow. In addition, or alternatively, the window of time before link layer retransmission may be less for TCP control packets than for regular data traffic. By having separate link flows for control and application data packets, the mobile terminal is able to apply differing reliability standards or requirements to the different packet types, thus providing increased flexibility.

Overall System and Mobile Terminal:

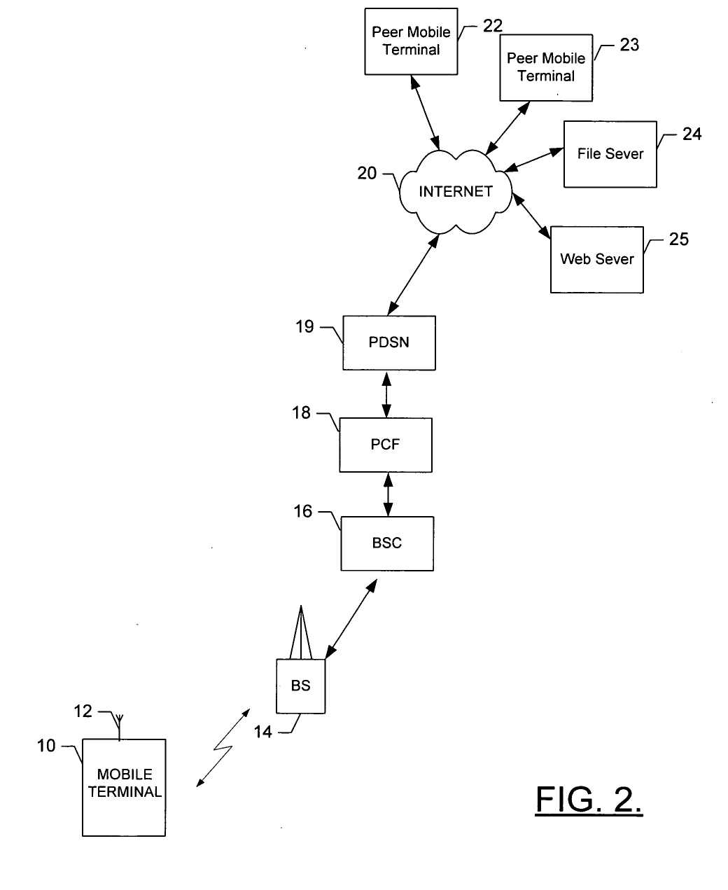

Referring to FIG. 2, an illustration of one type of system that would benefit from exemplary embodiments of the present invention is provided. The system can include one or more mobile terminals or stations 10, each having an antenna 12 for transmitting signals to and for receiving signals from one or more base stations (BS's) 14. The base station is a part of one or more cellular or mobile networks that each includes elements required to operate the network, such as one or more base station controllers (BSC) 16. In operation, the BSC is capable of allocating radio channels, receiving measurements from the mobile terminals, and controlling handover from BS to BS.

The BSC 16 can be coupled to a data network, such as a local area network (LAN), a metropolitan area network (MAN), and/or a wide area network (WAN). The BSC can be directly coupled to the data network. In one typical embodiment, however, the BSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile terminal 10 via the Internet. For example, the mobile terminal 10 may be coupled via the Internet to other peer mobile terminals 22, 23, for the purpose of e-mail or file transferring. In addition, the mobile terminal 10 may be connected via the Internet with a file server 24 for the purpose of downloading files or a web server 25 for web browsing. As will be appreciated, the processing elements can comprise any of a number of processing devices, systems or the like capable of operating in accordance with embodiments of the present invention.

Although not every element of every possible network is shown and described herein, it should be appreciated that the mobile terminal 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile terminals may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

Although not shown in FIG. 2, in addition to or in lieu of coupling the mobile terminals 10 to other peer mobile terminals 23, 23 or servers 24, 25 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile terminal 10 and other network entities (e.g., peer mobile terminals 22, 23, file server 24 and/or web server 25) can be coupled to one or more electronic devices, such as printers, digital projectors and/or other multimedia capturing, producing and/or storing devices (e.g., other terminals).

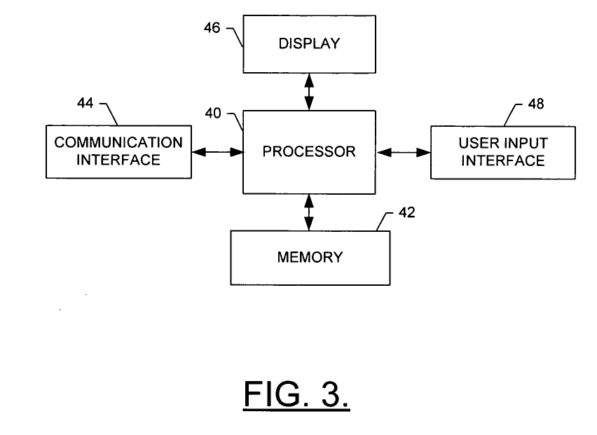

Referring now to FIG. 3, a block diagram of an entity capable of operating as a mobile terminal 10, intermediate agent (e.g., PDSN or router) and/or other network entity (e.g., file server 24, web server 25, or another mobile terminal 22, 23 with which the mobile terminal 10 can transfer e-mails or other files) is shown in accordance with one embodiment of the present invention. The entity capable of operating as a mobile terminal, intermediate agent and/or other network entity includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a mobile terminal 10, intermediate agent and/or other network entity 22, 23, 24, 25 can generally include means, such as a processor 40 connected to a memory 42, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

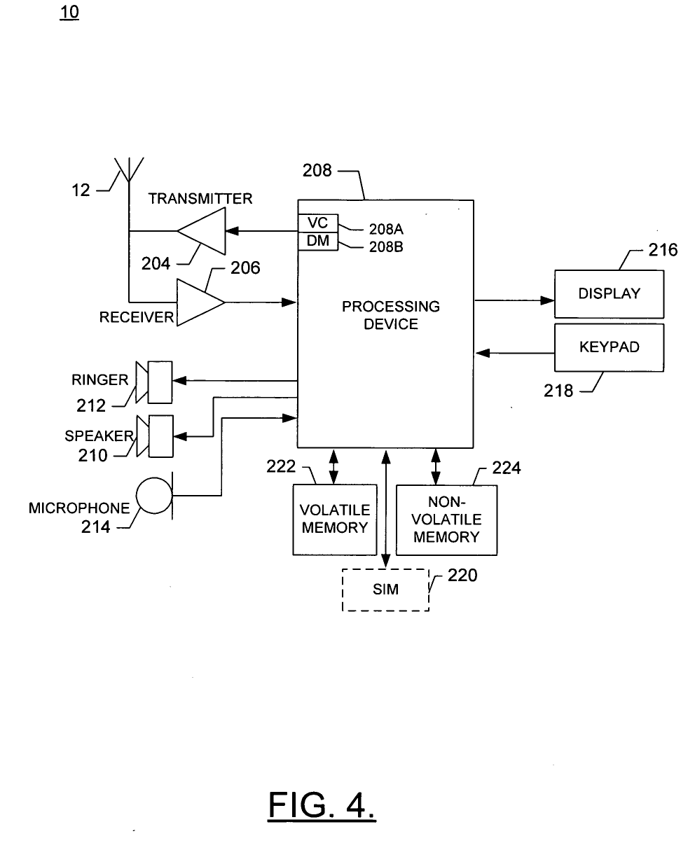

Reference is now made to FIG. 4, which illustrates one type of mobile terminal 10 that would benefit from embodiments of the present invention. It should be understood, however, that the mobile terminal illustrated and hereinafter described is merely illustrative of one type of mobile terminal that would benefit from the present invention and, therefore, should not be taken to limit the scope of the present invention. While several embodiments of the mobile terminal are illustrated and will be hereinafter described for purposes of example, other types of mobile terminals, such as personal digital assistants (PDAs), pagers, laptop computers and other types of electronic systems including both mobile, wireless devices and fixed, wireline devices, can readily employ embodiments of the present invention.

The mobile terminal includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 4, in addition to an antenna 12, the mobile terminal 10 includes a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile terminal can be capable of operating with one or more air interface standards, communication protocols, modulation types, and access types. More particularly, the mobile terminal can be capable of operating in accordance with any of a number of second-generation (2G), 2.5G and/or third-generation (3G) communication protocols or the like. Further, for example, the mobile terminal can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile terminal and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality of convolutional encoding and interleaving message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile terminal to transmit and receive Web content, such as according to HTTP and/or the Wireless Application Protocol (WAP), for example.

The mobile terminal may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile terminal and may include a full set of alphanumeric keys or set of keys that may be activated to provide a full set of alphanumeric keys. Although not shown, the mobile terminal may include a battery, such as a vibrating battery pack, for powering the various circuits that are required to operate the mobile terminal, as well as optionally providing mechanical vibration as a detectable output.

The mobile terminal can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile terminal can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile terminal. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for associating two separate link flows with the transmission of TCP control packets and TCP application data packets, respectively, wherein the link flow used for transmitting TCP control packets is more highly prioritized than the link flow used for transmitting TCP application data packets.

The system, method, mobile terminal or station and computer program product of exemplary embodiments of the present invention are primarily described in conjunction with mobile communications applications. It should be understood, however, that the system, method, mobile terminal and computer program product of embodiments of the present invention can be utilized in conjunction with a variety of other applications, both in the mobile communications industries and outside of the mobile communications industries. For example, the system, method, mobile terminal and computer program product of exemplary embodiments of the present invention can be utilized in conjunction with wireline and/or wireless network (e.g., Internet) applications.

Prioritization of TCP Control Packets:

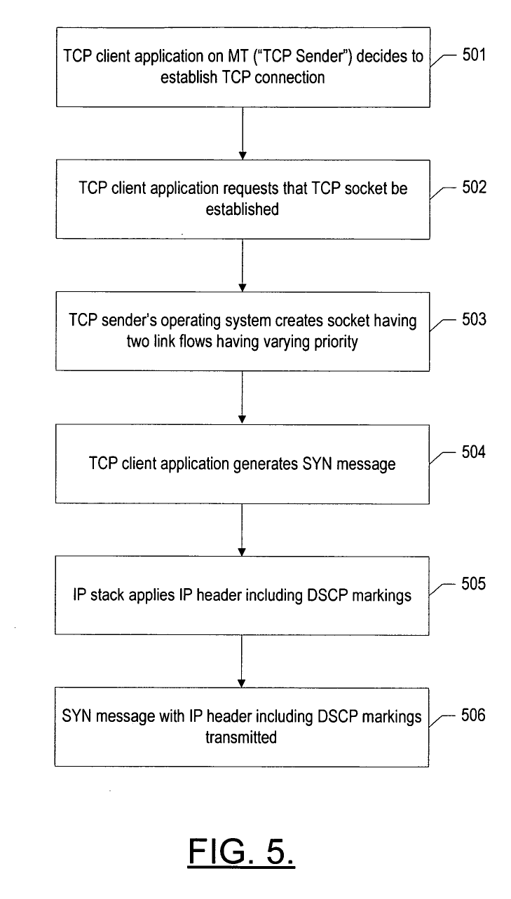

Reference is now made to FIG. 5, which illustrates the steps which may be taken in order to prioritize TCP control packets transmitted from the mobile terminal (i.e., on the uplink or reverse flow) in accordance with exemplary embodiments of the present invention. As shown, the process begins in Step 501 when a TCP client application operating on the mobile terminal (hereinafter “the TCP sender” decides to establish a TCP connection, for example, with another mobile terminal (hereinafter “the TCP receiver”. This may be for the purposes of e-mailing or transferring files. Alternatively, the mobile terminal may desire to establish a TCP connection with a web server for the purpose of browsing, or with a file server for the purpose of downloading files.

In Step 502, the TCP client application requests that a TCP socket be established. As is known by those of ordinary skill in the art, TCP provides a set of addresses or ports within each host system (in this instance the mobile terminal) in order to allow for many processes within a single host to use TCP communication facilities simultaneously. These ports are concatenated with the network and host addresses from the Internet communication layer in order to form a socket. Each connection between the host and network is, therefore, uniquely defined by a pair of sockets. Each socket may be used simultaneously in multiple connections (i.e., a local or host socket may participate in many connections to different foreign or network sockets).

In response to the request, in Step 503, the TCP sender's operating system will create a socket. In so doing, according to exemplary embodiments of the present invention, the operating system will configure the TCP stack of the TCP sender to define two air link connections (or link flows) to the base station, wherein one is to be used for TCP control packets (referred to as the “control link flow” and the other for application data traffic (referred to as the “application data link flow”. Exemplary embodiments of the present invention, therefore, propose defining a socket option which could be invoked by the TCP client application to indicate to the operating system and, in turn, the TCP sender's TCP stack that two link flows should be associated with the socket.

In one exemplary embodiment, the link flow established for TCP control packet traffic is shared by all TCP connections. In other words, the TCP control packets for all of the TCP applications running on the TCP sender are transmitted over the same control link flow. Alternatively, several such control link flows may be created for a group of applications on a one-to-one, one-to-two, one-to-three, and so forth, basis.

In one exemplary embodiment, the two link flows associated with the socket have varying priority levels associated with them. In particular, a priority level associated with the control link flow may be higher than a corresponding priority level associated with the application data link flow. These priority levels are specific to the air interface between the mobile terminal or TCP sender and the first edge router (e.g., the PDSN associated with the TCP sender). In one exemplary embodiment, the result of the control link flow having a higher priority level is that the TCP control packets transmitted over the control link flow will have faster packet queuing process times within the TCP sender than application data packets transmitted over the regular link flow. In other words, the TCP sender's operating system will transmit the TCP control packets faster than or before it processes or transmits the application data packets. In general, therefore, the control packets will themselves have a higher priority with respect to the application data packets over the air interface.

Once the socket has been created and the two link flows have been associated with the socket, the TCP client application on the TCP sender is now ready to initiate a connection with a server application operating on the TCP receiver. As stated above, the TCP receiver may, for example, be another mobile terminal with which the TCP sender wishes to send an e-mail or transfer files. Alternatively, the TCP receiver may be a web or file server, wherein the connection is for the purpose of web browsing or downloading files. In Step 504, therefore, the client application operating on the TCP sender will generate a SYN message (i.e., a TCP control packet) to be sent to the TCP receiver.

In order to further provide priority to the TCP control packet beyond the air interface between the mobile terminal or TCP sender and the nearest edge router (i.e., the intermediate agent), in Step 505, the operating system may configure the IP stack of the TCP sender to apply an IP header to the TCP control packet that indicates to the intermediate agent that the TCP control packet should be treated preferentially. For example, the IP header may include a DSCP marking. This DSCP marking will be read by the intermediate agent (e.g., router or PDSN) associated with the TCP sender in order to apply preferential treatment to the TCP control packet when sending the TCP control packet to the recipient or to an intermediate agent associated with the TCP receiver. The SYN message (i.e., the TCP control packet with IP header including the DSCP marking) is now ready to be transmitted over the control link flow to the TCP receiver (Step 506).

In one exemplary embodiment, in applying preferential treatment to TCP control packets, other priority management schemes may be born in mind. For instance, the subscription prices paid by various customers may be considered. For example, the intermediate agent (e.g., BSC/PDSN) receiving TCP control packets and application data packets from various customers may determine that the transmission of TCP application data packets of premium customers (i.e., customers who have subscribed to premium plans, typically by paying higher subscription prices) should not be delayed in order to give preference to TCP control packets of non-premium customers. Related to other non-premium customers, however, the TCP control packets of non-premium customers may be prioritized relative to application data packets of those non-premium customers. The TCP control packets of non-premium customers may, therefore, still enjoy some preferential treatment. In other exemplary embodiments, the TCP control packets may always receives the highest priority regardless of the subscription fee paid or the level of service due to the customer.

Another consideration when giving priority to TCP control packets is that exemplary embodiments of the present invention should provide prioritization while not violating the TCP specification. For example, control packets with dependency on earlier transmitted packets (e.g., an empty segment with the FIN bit set and including, in a sequence or acknowledgement number field in the TCP header, an indication that the connection should be disconnected only after an earlier packet in the sequence is received) should not be given priority.

Based on the foregoing, TCP control packets can be prioritized over application data traffic on the air link in the reverse direction (i.e., the uplink from the mobile terminal to the network entity). This is beneficial, since mobile terminals will likely often be the receiver and, therefore, the originator of multiple ACKs and other control signaling. In order to provide increased benefit, exemplary embodiments of the present invention will further provide for a dedicated control link flow in the forward direction (i.e., the downlink from the network entity to the mobile terminal). To continue with the process illustrated in FIG. 5, this would result in an ACK message being received by the TCP sender over the control link flow with the same elevated priority as that with which the SYN message was transmitted. Alternatively, the dedicated control link flow may be provided exclusively in the forward direction.

According to one exemplary embodiment of the present invention, in order to enable prioritization of TCP control packets in the forward direction (i.e., the downlink to the mobile terminal—in this case the TCP sender), a Traffic Flow Template (TFT) may be established by the mobile terminal at the intermediate agent (e.g., PDSN or other router). This may be done, for example, between Steps 503 and 504 above. The TFT contains a packet filter that can be matched by the PDSN against incoming forward traffic intended for the mobile terminal. Packet filter attributes that can be looked into by the PDSN include, for example, IP address, source port, destination port, destination IP address, etc. Using the packet filter, the PDSN, or other intermediate agent, is able to route all TCP control packets intended for the mobile terminal, as defined by the packet filter attributes, (in this case, the TCP sender) over the dedicated control link flow according to the elevated priority level previously assigned.

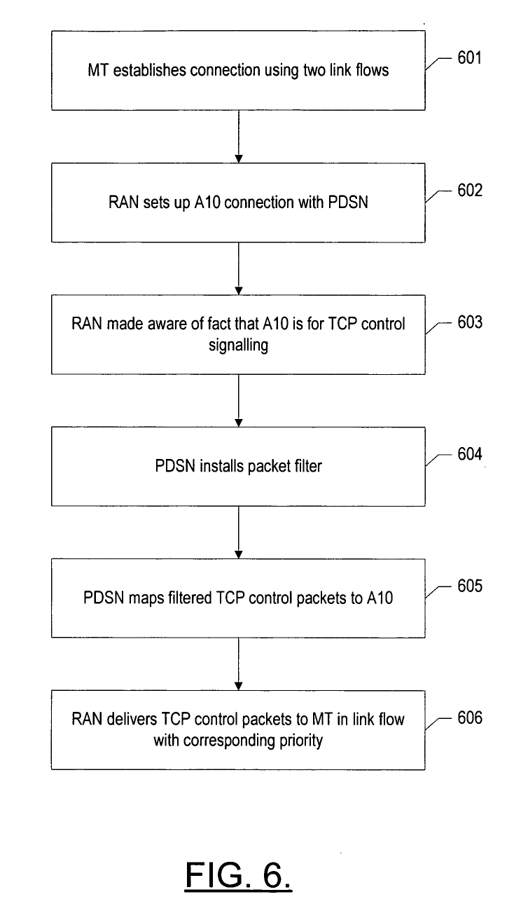

To further illustrate, FIG. 6 provides the steps which may be taken when providing prioritization in the forward direction in accordance with exemplary embodiments of the present invention, wherein the communication network is capable of supporting communication in accordance with CDMA2000 1×EV-DO.

First, in Step 601, the mobile terminal establishes a connection using two separate link flows—one for data and one for control signaling (in the manner discussed above with respect to FIG. 5). In response, in Step 602, the Radio Access Network (RAN) sets up an A10 connection with the Packet Data Serving Node (PDSN). As one of ordinary skill in the art will recognize an A10 interface carries user traffic between the Packet Control Function (PCF) and the PDSN. The RAN is then made aware, for example through A11 signaling (i.e., signaling information between the PCF and the PDSN) or Resource ReSerVation Protocol (RSVP) from the mobile terminal, that this connection (i.e., the A10 connection) is for TCP control signaling (Step 603). The PDSN then, in Steps 604 and 605, respectively, installs a packet filter to identify TCP control packets intended for the mobile terminal, and maps the filtered control packets to the A10 interface towards the RAN set-up with an appropriate priority. The RAN would thus know to deliver the TCP control packets to the mobile terminal in a link flow with the corresponding priority (Step 606).

According to exemplary embodiments, all intermediate forwarding agents (e.g., IP routers in the case of wireless environments, or packet schedulers in base stations) are made aware of the differentiation between TCP control packets and application data traffic.

Increasing Reliability:

In one exemplary embodiment, in addition to assigning a higher priority to TCP control packets, the TCP sender may further improve upon the position of TCP control packets with respect to application data by increasing the number of link layer retransmissions over the control link flow. In other words, the TCP sender may specify that TCP control packets should be retransmitted at the link layer more times than a normal application data packet would be retransmitted, thus improving upon the reliability of TCP control packets. In addition, or alternatively, the mobile terminal may indicate that a shorter window of time should elapse before the TCP control packet is retransmitted, again resulting in increased reliability. One goal is, therefore, to increase the likelihood that TCP control packets will be received successfully.

Conclusion:

Exemplary embodiments of the present invention provide an improvement over known TCP systems by providing faster connection set-up, prevention of otherwise possible slowdown in data rates on a TCP stream due to slow start or retransmission, and better network utilization.

As described above and as will be appreciated by one skilled in the art, embodiments of the present invention may be configured as a system, method, mobile terminal device or other apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of transmitting one or more control packets and one or more application data packets, said method comprising:
associating a first link flow with transmission of the one or more control packets;
associating a second link flow with transmission of the one or more application data packets;
transmitting one or more control packets over the first link flow; and
transmitting one or more application data packets over the second link flow, wherein the one or more control packets have a higher priority than the one or more application data packets, and wherein transmitting the one or more control packets over the first link flow comprises transmitting the one or more control packets with the higher priority over the first link flow.

2. The method of claim 1, wherein the first link flow is more highly prioritized than the second link flow.

3. The method of claim 1 further comprising:
including a marking with respective control packets to indicate the priority of the control packets.

4. The method of claim 1, wherein the control packets comprise transmission control protocol (TCP) control packets, and wherein the application data packets comprise TCP application data packets.

5. The method of claim 4 further comprising:
receiving a request for establishment of a TCP socket, wherein the steps of associating the first link flow with transmission of the one or more control packets and associating the second link flow with transmission of the one or more application data packets are automatically performed in response to receiving said request.

6. The method of claim 4 further comprising:
defining a number of times a link layer frame containing a TCP control packet will be retransmitted, wherein the number of times the frame will be retransmitted is greater than a number of times a link layer frame containing a TCP application data packet will be retransmitted.

7. The method of claim 4 further comprising:
defining a window of time before which a link layer frame containing a TCP control packet will be retransmitted, wherein the window of time is shorter than a window of time before which a link layer frame containing a TCP application data packet will be retransmitted.

8. The method of claim 1, wherein transmitting one or more control packets with the higher priority over the first link flow comprises transmitting the control packets sooner than the application data packets.

9. The method of claim 3, wherein transmitting one or more control packets comprises transmitting the control packets from a mobile terminal to an intermediate agent, and wherein the marking indicates to the intermediate agent the priority of the one or more control packets.

10. The method of claim 9 further comprising:
establishing a packet filter at the intermediate agent, said packet filter capable of being used by the intermediate agent to route one or more control packets intended for the mobile terminal over the first link flow in accordance with the priority of the control packets.

11. The method of claim 9, wherein the intermediate agent comprises a Packet Data Serving Node.

12. The method of claim 9, wherein the priority of the control packets is based at least in part on a level of service to be provided to a user associated with the mobile terminal.

13. A mobile terminal capable of transmitting one or more control packets and one or more application data packets, said mobile terminal comprising:
a processor; and
a memory in communication with the processor, said memory comprising an application executable by the processor, wherein the application is capable, upon execution, of associating a first link flow with transmission of the one or more control packets and associating a second link flow with transmission of the one or more application data packets, said application further capable, upon execution, of transmitting one or more control packets over the first link flow and transmitting one or more application data packets over the second link flow, wherein the one or more control packets have a higher priority than the one or more application data packets, and wherein transmitting the one or more control packets over the first link flow comprises transmitting the one or more control packets with the higher priority over the first link flow.

14. The mobile terminal of claim 13, wherein the first link flow is more highly prioritized than the second link flow.

15. The mobile terminal of claim 13, wherein the application is further capable, upon execution, of including a marking with respective control packets to indicate the priority of the control packets.

16. The mobile terminal of claim 13, wherein the control packets comprise transmission control protocol (TCP) packets, and wherein the application data packets comprise TCP application data packets.

17. The mobile terminal of claim 16, wherein the application is further capable, upon execution, of receiving a request for establishment of a TCP socket, and wherein associating the first and second link flows with the control packets and the application data packets, respectively, comprises automatically associating the first and second link flows with the control packets and application data packets, respectively, in response to receiving the request.

18. The mobile terminal of claim 16 wherein the application is further capable, upon execution, of defining a number of times a link layer frame containing a TCP control packet will be retransmitted, wherein the number of times the frame will be retransmitted is greater than a number of times a link layer frame containing a TCP application data packet will be retransmitted.

19. The mobile terminal of claim 16, wherein the application is further capable, upon execution, of defining a window of time before which a link layer frame containing a TCP control packet will be retransmitted, wherein the window of time is shorter than a window of time before which a link layer frame containing a TCP application data packet will be retransmitted.

20. The mobile terminal of claim 13, wherein transmitting one or more control packets with the higher priority over the first link flow comprises transmitting the control packets sooner than the application data packets.

21. The mobile terminal of claim 15, wherein transmitting one or more control packets comprises transmitting the control packets to an intermediate agent, and wherein the marking indicates to the intermediate agent the priority of the one or more control packets.

22. The mobile terminal of claim 21, wherein the application is further capable, upon execution, of establishing a packet filter at the intermediate agent, said packet filter capable of being used by the intermediate agent to route one or more control packets intended for the mobile terminal over the first link flow in accordance with the priority of the control packets.

23. The mobile terminal of claim 21, wherein the intermediate agent comprises a Packet Data Serving Node.

24. The mobile terminal of claim 13, wherein the priority of the control packets is based at least in part on a level of service to be provided to a user associated with the mobile terminal.

25. A system for transmitting one or more control packets and one or more application data packets, said system comprising:
a mobile terminal capable of associating a first link flow with the one or more control packets and associating a second link flow with the one or more application data packets, said mobile terminal further capable of transmitting one or more control packets over the first link flow and transmitting one or more application data packets over the second link flow, wherein the one or more control packets have a higher priority than the one or more application data packets, and wherein transmitting the one or more control packets over the first link flow comprises transmitting the one or more control packets with the higher priority over the first link flow; and
a network entity in communication with the mobile terminal, said network entity capable of receiving the one or more control packets with the higher priority from the mobile terminal.

26. The system of claim 25, wherein the first link flow is more highly prioritized than the second link flow.

27. The system of claim 25, wherein the mobile terminal is further capable of including a marking with respective control packets to indicate the priority of the control packets.

28. The system of claim 25, wherein the control packets comprise transmission control protocol (TCP) control packets and the application data packets comprise TCP application data packets.

29. The system of 28, wherein associating the first and second link flows with the one or more control packets and the one or more application data packets, respectively, comprises automatically associating the first and second link flows in response to receiving a request from a TCP client application operating on the mobile terminal for establishment of a TCP socket.

30. The system of claim 28, wherein the mobile terminal is further capable of defining a number of times a link layer frame containing a TCP control packet will be retransmitted, wherein the number of times the frame will be retransmitted is greater than a number of times a link layer frame containing a TCP application data packet will be retransmitted.

31. The system of claim 28, wherein the mobile terminal is further capable of defining a window of time before which a link layer frame containing a TCP control packet will be retransmitted, wherein the window of time is shorter than a window of time before which a link layer frame containing a TCP application data packet will be retransmitted.

32. The system of claim 25, wherein transmitting one or more control packets with the higher priority over the first link flow comprises transmitting the control packets sooner than the application data packets.

33. The system of claim 25, wherein the mobile terminal is further capable of establishing a packet filter at the network entity, and wherein the network entity is further capable of using the packet filter to route one or more control packets intended for the mobile terminal over the first link flow in accordance with the priority of the control packets.

34. The system of claim 25, wherein the network entity comprises a Packet Data Serving Node.

35. A network entity capable of sending and receiving one or more control packets with a higher priority than one or more application data packets, the network entity comprising:
a processor; and
a memory in communication with the processor, said memory storing an application executable by the processor, wherein the application is capable, upon execution, of receiving one or more control packets over a control link flow and one or more application data packets over an application data link flow, said application further capable, upon execution, of interpreting a marking included with respective control packets received to determine a priority of the respective control packets, and the application further capable, upon execution, of transmitting the control packets received in accordance with the priority.

36. The network entity of claim 35, wherein the control packets are transmission control protocol (TCP) control packets and the application data packets are TCP application data packets.

37. The network entity of claim 36, wherein the TCP control packets and the TCP application data packets are received from a mobile terminal over the control link flow and the application data link flow, respectively.

38. The network entity of claim 37, wherein the application is further capable, upon execution, of receiving one or more TCP packets intended for the mobile terminal, said TCP packets comprising one or more TCP control packets and one or more TCP application data packets, said application further capable, upon execution, of filtering the TCP packets received in order to isolate the one or more TCP control packets, and said application further capable, upon execution, of transmitting the one or more TCP control packets to the mobile terminal over the control link flow in accordance with the prioritization.

39. A computer program product for transmitting one or more control packets and one or more application data packets, wherein the computer program product comprises at least one computer-readable storage medium having computer-readable program code portions stored therein, the computer-readable program portions comprising:
a first executable portion for associating a first link flow with the one or more control packets;
a second executable portion for associating a second link flow with the one or more application data packets;
a third executable portion for transmitting one or more control packets over the first link flow; and
a fourth executable portion for transmitting one or more application data packets over the second link flow, wherein the one or more control packets have a higher priority than the one or more application data packets, and wherein transmitting the one or more control packets over the first link flow comprises transmitting the one or more control packets with the higher priority over the first link flow.

40. The computer program product of claim 39, wherein the first link flow is more highly prioritized than the second link flow.

41. The computer program product of claim 39 further comprising:
a fifth executable portion for including a marking with respective control packets to indicate the priority of the control packets.

42. The computer program product of claim 39, wherein the control packets comprise transmission control protocol (TCP) packets, and wherein the application data packets comprise TCP application data packets.

43. The computer program product of claim 42 further comprising:
a fifth executable portion for receiving a request for establishment of a TCP socket, and wherein associating a first and second link flow with the one or more control packets and one or more application data packets, respectively, comprises automatically associating the first and second link flows in response to receiving the request.

44. The computer program product of claim 42 further comprising:
a fifth executable portion for defining a number of times a link layer frame containing a TCP control packet will be retransmitted, wherein the number of times the frame will be retransmitted is greater than a number of times a link layer frame containing a TCP application data packet will be retransmitted.

45. The computer program product of claim 42 further comprising:
a fifth executable portion for defining a window of time before which a link layer frame containing a TCP control packet will be retransmitted, wherein the window of time is shorter than a window of time before which a link layer frame containing a TCP application data packet will be retransmitted.

46. The computer program product of claim 39, wherein transmitting one or more control packets with the higher priority over the first link flow comprises transmitting the control packets sooner than the application data packets.

47. The computer program product of claim 41, wherein transmitting one or more control packets comprises transmitting the control packets from a mobile terminal to an intermediate agent, and wherein the marking indicates to the intermediate agent the priority of the control packets.

48. The computer program product of claim 47 further comprising:
a sixth executable portion for establishing a packet filter at the intermediate agent, said packet filter capable of being used by the intermediate agent to route one or more control packets intended for the mobile terminal over the first link flow in accordance with the priority of the control packets.

49. The computer program product of claim 47, wherein the intermediate agent comprises a Packet Data Serving Node.

50. The computer program product of claim 47, wherein the priority of the control packets is based at least in part on a level of service to be provided to a user associated with the mobile terminal.
